(19) United States
(12) Patent Application Publication
(10) Pub. No.: US 2008/0198083 A1
(43) Pub. Date: Aug. 21, 2008

(54) PRIMARY RADIATOR

(76) Inventor: Yukihiro YAMAGUCHI, Sakai-shi (JP)

Correspondence Address: BIRCH STEWART KOLASCH & BIRCH, PO BOX 747, FALLS CHURCH, VA, 22040-0747, US

(21) Appl. No.: 11/963,235

(22) Filed: Dec. 21, 2007

(30) Foreign Application Priority Data
Feb. 20, 2007 (JP) 2007-040024

(51) Int. Cl. H01Q 13/02

(52) U.S. Cl. 343/786

(57) ABSTRACT

To produce a primary radiator including a horn part and a waveguide, the cross section of which is elliptical shape, and which can be easily formed, so that production cost is reduced, a primary radiator 3 of the present invention is so arranged that it includes a horn part 3a and a waveguide 3b which are formed in one piece by deep-drawing process.

This nonprovisional application claims priority under 35 U.S.C. §119(a) on Patent Application No. 040024/2007 filed in Japan on Feb. 20, 2007, the entire contents of which are hereby incorporated by reference.

### FIELD OF THE INVENTION

The present invention relates to a primary radiator which is used for a converter for receiving satellite broadcast and satellite communication such as a low noise block converter (LBN). More particularly, the invention relates to a primary radiator including a horn part and a waveguide part, and a method of producing the primary radiator.

### BACKGROUND OF THE INVENTION

A parabolic antenna used for receiving satellite broadcast and satellite communication includes: a reflector which focuses electric waves from satellites on a focal point; a primary radiator which collects the electric waves; and a converter which amplifies the electric waves and transforms the frequencies.

A primary radiator includes a waveguide one end of which is open and the other end of which is closed, and a first probe and a second probe inserted inside from the wall of the waveguide. The shape of the cross section of the waveguide may be round, for example. The first and the second probes are placed at right angles to each other. A distance between each probe and the closed end of the waveguide is about one fourth of wavelength in the waveguide.

In the primary radiator as described above, when linearly-polarized waves from a satellite are captured by the reflector and guided into the waveguide, the waves are detected by the probes. For example, the vertically-polarized waves are detected by the first probe, and the horizontally-polarized waves are detected by the second probe. The detection signals from both the probes are converted to signals carried at intermediate frequency (IF) in a converter circuit and outputted. In this way, the electric waves from the satellite can be received.

A conventional primary radiator generally used is manufactured from aluminum and zinc by die-casting process. FIG. 10 shows an assembling cross section view of a LNB manufactured by die-casting process. Chassis 10 of the LNB includes a corrugated horn part 10a and a waveguide 10b which are integrally molded.

As another method, spin casting is also used for producing primary radiators, as disclosed in Japanese Unexamined Patent Application Publication No. 58-154901 (published on Sep. 14, 1983).

Furthermore, Japanese Unexamined Patent Application Publication No. 2004-336154 (published on Nov. 25, 2004) discloses a technology of producing a waveguide with a corrugated horn part from a sheet metal by bending process.

However, the die-casting process to manufacture the primary radiator is complicated because the horn part and the waveguide should be molded in one piece, and costly dies are required. And also, the primary radiator becomes heavy because of die-casting.

In the spin casting process, the weight of the primary radiator is light. But, unfortunately, only a horn part and a waveguide whose cross section is round can be manufactured.

Furthermore, in the bending process, a corrugated horn part which has a low noise effect is added, and a light primary radiator can be manufactured. However, unfortunately, a primary radiator with a corrugated horn part and a waveguide whose cross section is elliptical cannot be manufactured.

### SUMMARY OF THE INVENTION

The present invention is accomplished in view of the problems discussed above. An object of the present invention is to provide a method of producing a primary radiator in which a cross section of a horn part and a waveguide is elliptical, and which leads to reduce production costs.

In order to achieve the above object, a primary radiator in accordance with the present invention includes a horn part and a waveguide which are molded by deep-drawing process.

Drawing process is a metal forming process in which a sheet metal is processed by a press machine so that a depressed area is deformed without any seams. Deep-drawing process is a metal forming process in which a flat sheet plate sheared in a determined shape is drawn into a molding die by mechanical action of a punch. The molding die and the punch are used as a pair. The process is used for forming a circular plate into a cylindrical cup.

In accordance with the above description, a primary radiator is produced by deep-drawing a sheet plate which has plastic deformation property and conductivity to form a horn part and a waveguide in one piece. It enables process time to be shortened and production cost to be reduced.

The sheet plate to be processed may be not only a metal plate, but also a plating resin.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 are views illustrating details of a primary radiator in accordance with a second embodiment of the present invention. FIG. 1(a) is a side view of the primary radiator. FIG. 1(b) is a front view of the primary radiator. FIG. 1(c) is the cross sectional view of the primary radiator taken along line A-A′ of FIG. 1(b).

FIG. 2 are views illustrating details of a primary radiator in accordance with a first embodiment of the present invention. FIG. 2(a) is a side view of the primary radiator. FIG. 2(b) is a front view of the primary radiator. FIG. 2(c) is a cross sectional view of the primary radiator taken along line A-A′ of FIG. 2(b).

FIG. 3 is a cross section of a chassis of a converter for receiving satellite broadcast and satellite communication (LNB) in accordance with a first embodiment of the present invention. The converter is formed by deep-drawing process in which a horn part and a waveguide are molded in one piece.

FIG. 4 are views illustrating details of a primary radiator in accordance with a third embodiment of the present invention. FIG. 4(a) is a side view of the primary radiator. FIG. 4(b) is a front view of the primary radiator. FIG. 4(c) is a cross sectional view of the primary radiator taken along line A-A′ of FIG. 4(b).

FIG. 5 are views illustrating details of a primary radiator in accordance with a fourth embodiment of the present invention. FIG. 5(a) is a side view of a horn part. FIG. 5(b) is a front of the horn part. FIG. 5(c) is a cross sectional view of the horn part taken along line A-A′ of FIG. 5(b). FIG. 5(d) is a side view of a waveguide. FIG. 5(e) is a front view of the waveguide. FIG. 5(f) is a cross sectional view of the waveguide taken along line B-B′ of FIG. 5(e).

FIG. 6 are views illustrating details of a primary radiator in accordance with a fifth embodiment of the present invention. FIG. 6(a) is a side view of a horn part. FIG. 6(b) is a front view of the horn part. FIG. 6(c) is a cross sectional view of the horn part taken along line A-A′ of FIG. 6(b). FIG. 6(d) is a side view of a waveguide. FIG. 6(e) is a front view of the waveguide. FIG. 6(f) is a cross sectional view of the waveguide taken along line B-B′ of FIG. 6(e).

FIG. 7 are views illustrating details of a primary radiator in accordance with a sixth embodiment of the present invention. FIG. 7(a) is a side view of a horn part. FIG. 7(b) is a front view of the horn part. FIG. 7(c) is a cross sectional view of the horn part taken along line A-A′ of FIG. 7(b). FIG. 7(d) is a side view of a waveguide. FIG. 7 (e) is a front view of the waveguide. FIG. 7(f) is a cross sectional view of the waveguide taken along line B-B′ of FIG. 7(c).

FIG. 8 are views illustrating details of a primary radiator in accordance with a seventh embodiment of the present invention. FIG. 8(a) is a side view of the primary radiator. FIG. 8(b) is a front view of the primary radiator. FIG. 8(c) is a cross sectional view of the primary radiator taken along line A-A′ of FIG. 8(b).

FIG. 9 are graphs which show radiating patterns of electric waves. FIG. 9(a) shows radiating patterns of a primary radiator whose flange end of a horn part is bended. FIG. 9(b) shows radiating patterns of a primary radiator whose flange end of a horn part is not bended.

FIG. 10 is a cross sectional view of a conventional converter for receiving satellite broadcast and satellite communication (LNB). The converter is formed by die-casting process.

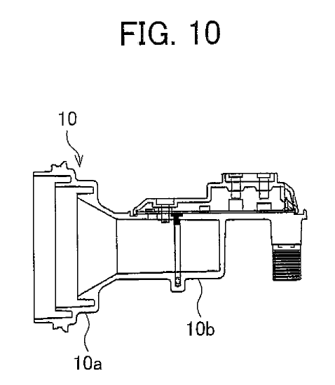

### DESCRIPTION OF THE EMBODIMENTS

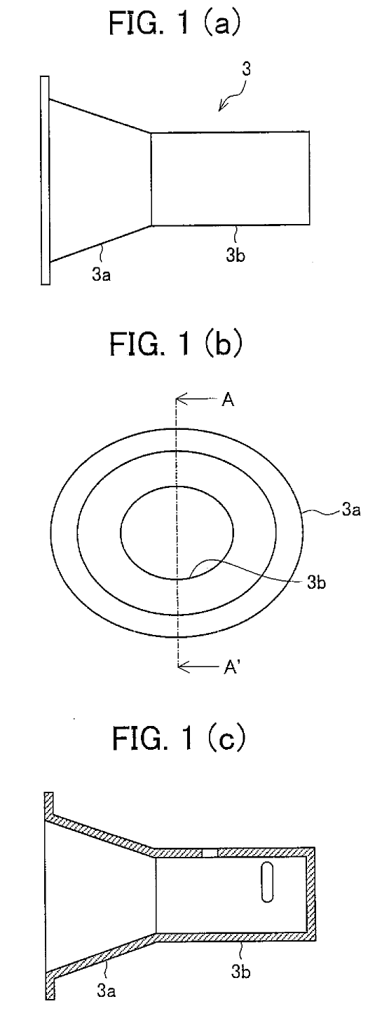

Preferred embodiments of the present invention are described hereinafter with reference to FIGS. 1 through 9.

### First Embodiment

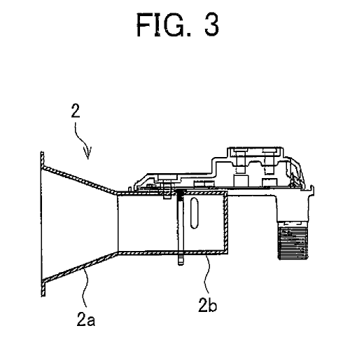

FIG. 3 is a full sectional view of a converter for receiving satellite broadcast and satellite communication called low noise converter block (LNB). A primary radiator 2 in the LNB includes a horn part 2a and a waveguide 2b. The drawings mentioned later illustrate the primary radiator 2 only partially.

The primary radiator 2 is produced by deep-drawing a sheet metal to mold a horn part and a waveguide in one piece. In deep-drawing process a thin sheet metal is processed as in spin casting and bending process. Thus, the waveguide with the horn part can be produced without using a complicated and costly die-casting die.

A sheet plate having plastic deformation property and electric conductivity can be used for deep-drawing process. So, not only the sheet metal, but also a sheet plate like a plating resin board may be preferably used.

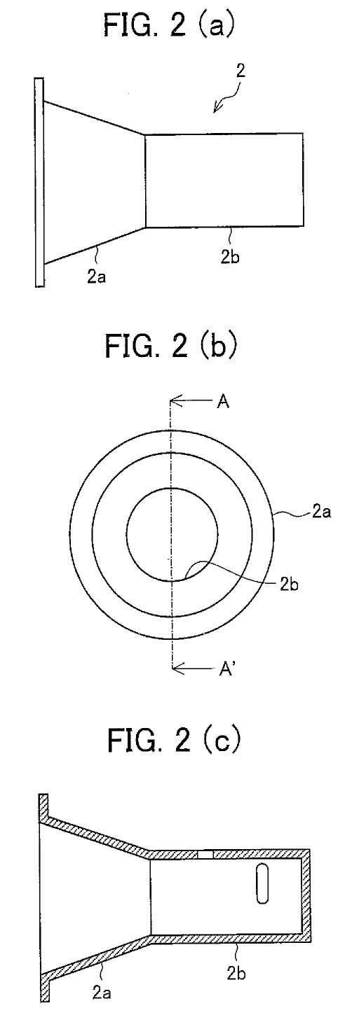

FIG. 2 are views illustrating details of the primary radiator 2 in accordance with the first embodiment. FIG. 2(a) is a side view of the primary radiator 2, FIG. 2(b) is a front view of the primary radiator 2, and FIG. 2(c) is a cross sectional view of the primary radiator 2 taken along line A-A′ of FIG. 2(b).

A horn part 2a is in the shape of a cone, the top of which is cut away, and at the base of which a flange is formed. A waveguide 2b is in the shape of a cylinder. One end of the waveguide 2b which is far from the horn part 2a is closed. As illustrated in FIG. 2(b), the shapes of the cross sections of the horn part 2a and the waveguide 2b are round.

The following embodiments of the present invention show only different parts from the first embodiment.

### Second Embodiment

FIG. 1 are views illustrating details of a primary radiator 3 in accordance with the second embodiment. FIG. 1(a) is a side view of the primary radiator 3, FIG. 1(b) is a front view of the primary radiator 3, and FIG. 1(c) is a cross sectional view of the primary radiator 3 taken along line A-A′ of FIG. 1(b).

As illustrated in the front view of FIG. 1(b), the shapes of the cross sections of a horn part 3 and a waveguide 3 are elliptical, which are different from the round shapes of those of the first embodiment. A flange is formed at a wide-open end of the horn part 3a. A narrow-open end of the horn part 3a is in the same shape and size as an open end of the waveguide 3b. The other end of the waveguide 3b which is far from the horn part 2a is closed.

### Third Embodiment

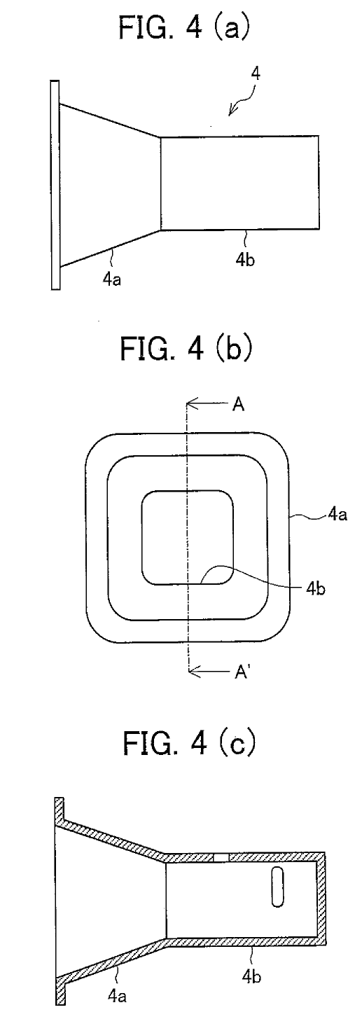

FIG. 4 are views illustrating details of a primary radiator 4 in accordance with the third embodiment. FIG. 4(a) is a side view of the primary radiator 4, FIG. 4(b) is a front view of the primary radiator 4, and FIG. 4(c) is a cross sectional view of the primary radiator 4 taken along line A-A′ of FIG. 4(b).

As illustrated in the front view of FIG. 4(b), the shapes of the cross section of a horn part 4a and a waveguide 4b are rectangular, which are different from the round shapes of those of the first embodiment and the elliptical shapes of those of the second embodiment. The horn part 4a is in the shape of a quadrangular pyramid, the top of which is cut away, and at the base of which a flange is formed. The waveguide 4b is in the shape of a square pole. An open end of the waveguide 4b is in the same shape and size as a narrow-open end of the horn part 4a. The other end of the waveguide 4b which is far from the horn part 4a is closed.

### Outline from the First Embodiment to the Third Embodiment

As shown in FIGS. 1 through 4, the primary radiators 2 through 4 are produced by deep-drawing a sheet metal to mold a horn part and a waveguide in one piece. Spin casting can form only a horn part and a waveguide, whose cross sections are round. Bending process cannot form a horn part and a waveguide whose cross sections are curved. But, deep-drawing process can easily form a horn part and a waveguide, whose cross sections are elliptical.

### Fourth Embodiment

In accordance with the forth embodiment, a process of producing a primary radiator is different from the above embodiments. A primary radiator is produced by deep-drawing individual sheet metals to respectively form a horn part and a waveguide, and joining them together in one piece.

This process requires an extra process of joining. But the shapes of the horn part and the waveguide are simpler so that they can be more easily formed by deep-drawing process.

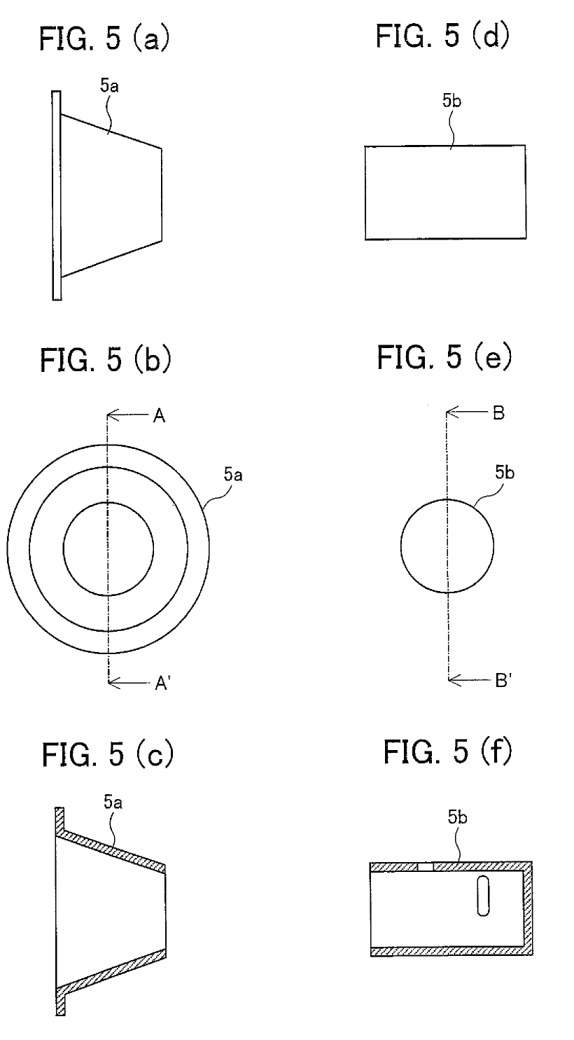

FIG. 5 are detail views of a primary radiator 5 in accordance with the fifth embodiment. FIG. 5(a) is a side view of a horn part 5a, FIG. 5(b) is a front view of the horn part 5a, and FIG. 5(c) is a cross sectional view of the horn part 5a taken along line A-A′ of FIG. 5(b). FIG. 5(d) is a side view of a waveguide 5b, FIG. 5(e) is a front view of the waveguide 5b, and FIG. 5(f) is a cross sectional view of the waveguide 5b taken along line B-B′ of FIG. 5(e).

The horn part 5a is in the shape of a cone, the top of which is cut away, and at the base of which a flange is formed. The waveguide 5b is in the shape of a cylinder. One end of the waveguide 5b which is far from the horn part 5a is closed. As illustrated in front views of FIGS. 5(b) and (e), the shapes of the cross sections of the horn part 5a and the waveguide 5b are round.

### Fifth Embodiment

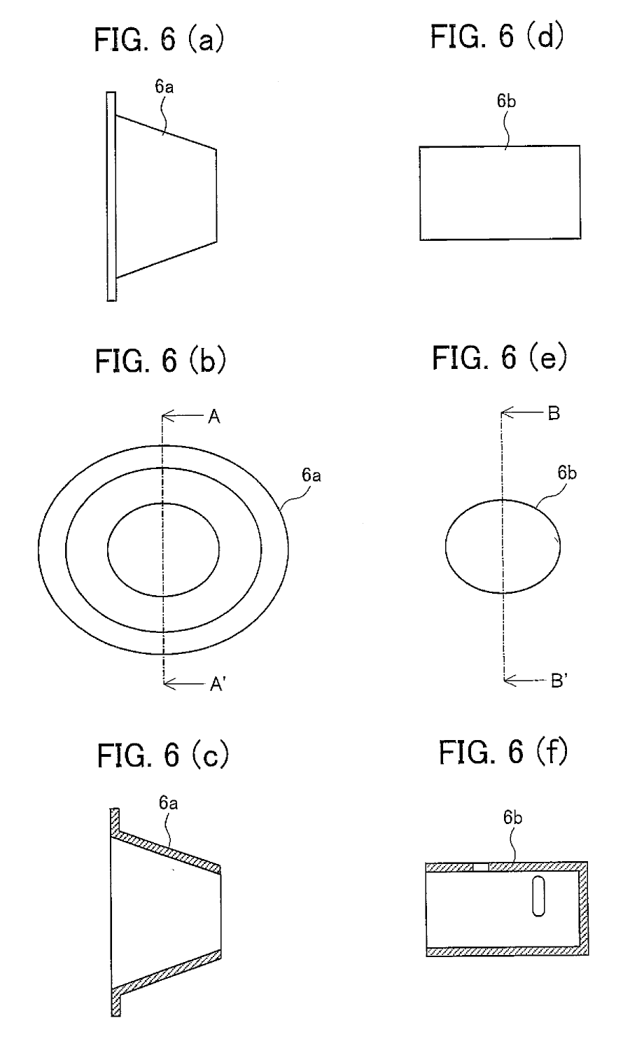

FIG. 6 are views illustrating details of a primary radiator 6 in accordance with the fifth embodiment. FIG. 6(a) is a side view of a horn part 6a, FIG. 6(b) is a front view of the horn part 6a, and FIG. 6(c) is a cross sectional view of the horn part 6a taken along line A-A′ of FIG. 6(b). FIG. 6(d) is a side view of a waveguide 6b, FIG. 6(e) is a front view of the waveguide 6b, and FIG. 6(f) is a cross sectional view of the waveguide 6b taken along line B-B′ of FIG. 6(e).

As shown in the front views of FIGS. 6(b) and (e), the shapes of the cross sections of the horn part 6a and the waveguide 6b are elliptical. A flange is formed at a wide-open end of the horn part 6a, and the cross section of a narrow-open end of the horn part 6a is the same shape and size as an open end of the waveguide 6b. The waveguide 6b is in the shape of a cylinder. One end of the waveguide 6b which is joined with the horn part 6a is open, and the other end of the waveguide 6b which is far from the horn par 6a is closed.

### Sixth Embodiment

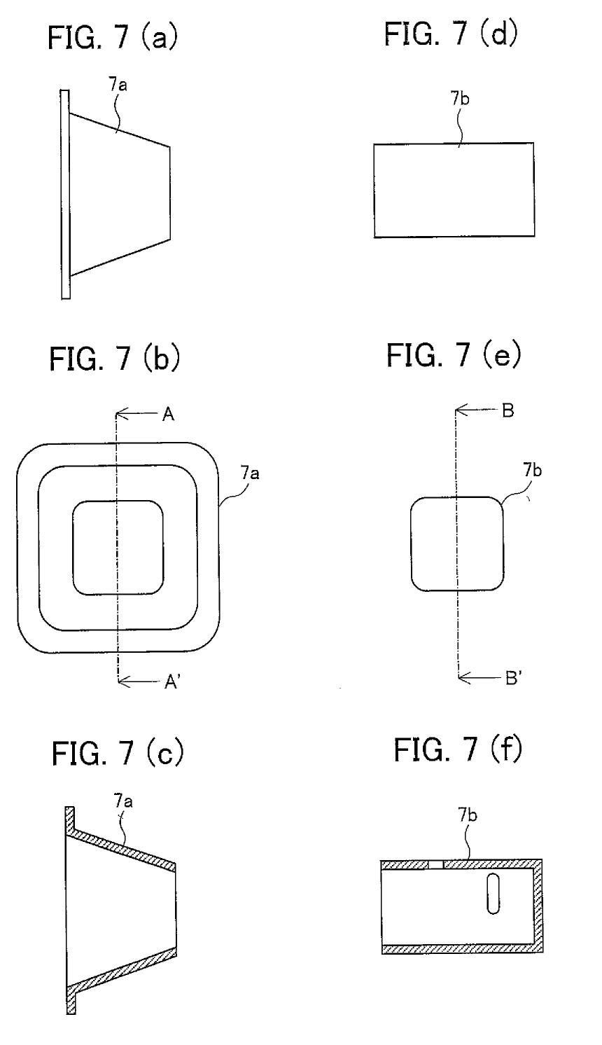

FIG. 7 are views illustrating details of a primary radiator 7 in accordance with the sixth embodiment. FIG. 7(a) is a side view of a horn part 7a, FIG. 7(b) is a front view of the horn part 7a, and FIG. 7(c) is a cross sectional view of the horn part 7a taken along line A-A′ of FIG. 7(b). FIG. 7(d) is a side view of a waveguide 7b, FIG. 7(e) is a front view of the waveguide 7b, and FIG. 7(f) is a cross sectional view of the waveguide 7b taken along line B-B′ of FIG. 7(e).

As illustrated in the front views of FIGS. 7(b) and (e), the shapes of the cross sections of the horn part 7a and the waveguide 7b are rectangular. The horn part 7a is in the shape of a quadrangular pyramid, the top of which is cut away, and at the base of which a flange is formed. The waveguide 7b is in the shape of a square pole. An open end of the waveguide 7b is joined with a narrow-open end of the horn part 7a. The other end of the waveguide 7b which is far from the horn part 7a is closed.

### Outline from the Fourth Embodiment to the Sixth Embodiment

As illustrated in FIGS. 5 through 7, the primary radiators 5 through 7 are produced by deep-drawing individual sheet metals to respectively form a horn part and a waveguide, and joining them together in one piece.

In the case of respectively forming a horn part and a waveguide, spin casting can form only a horn part and a waveguide whose cross sections are round. Also, bending process cannot form a horn part and a waveguide whose cross sections are curved. But, deep-drawing process can easily form a horn part and a waveguide whose cross sections are elliptical.

### Seventh Embodiment

In the seventh embodiment, bending is processed on a flange end of the horn part of each primary radiator as described in the above embodiments. The following describes an example in which bending is processed on a flange end of the horn part of the primary radiator in accordance with the first embodiment. In the primary radiator, the horn part and the waveguide are molded in one piece, and the cross section is round. Of course, the bending process is also applicable to other shaped primary radiators.

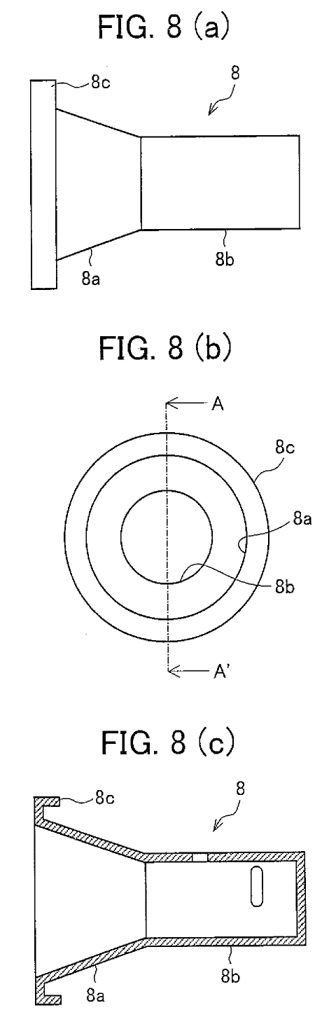

FIG. 8 are views illustrating details of a primary radiator 8 in accordance with the seventh embodiment. FIG. 8(a) is a side view of the primary radiator 8, FIG. 8(b) is a front view of the primary radiator 8, and FIG. 8(c) is a cross section of the primary radiator 8 taken along line A-A′ of FIG. 8(c).

As illustrated in FIG. 8(c), a flange end 8c of a horn part 8a is bended toward a waveguide 8b.

The bending process improves the strength of the horn part.

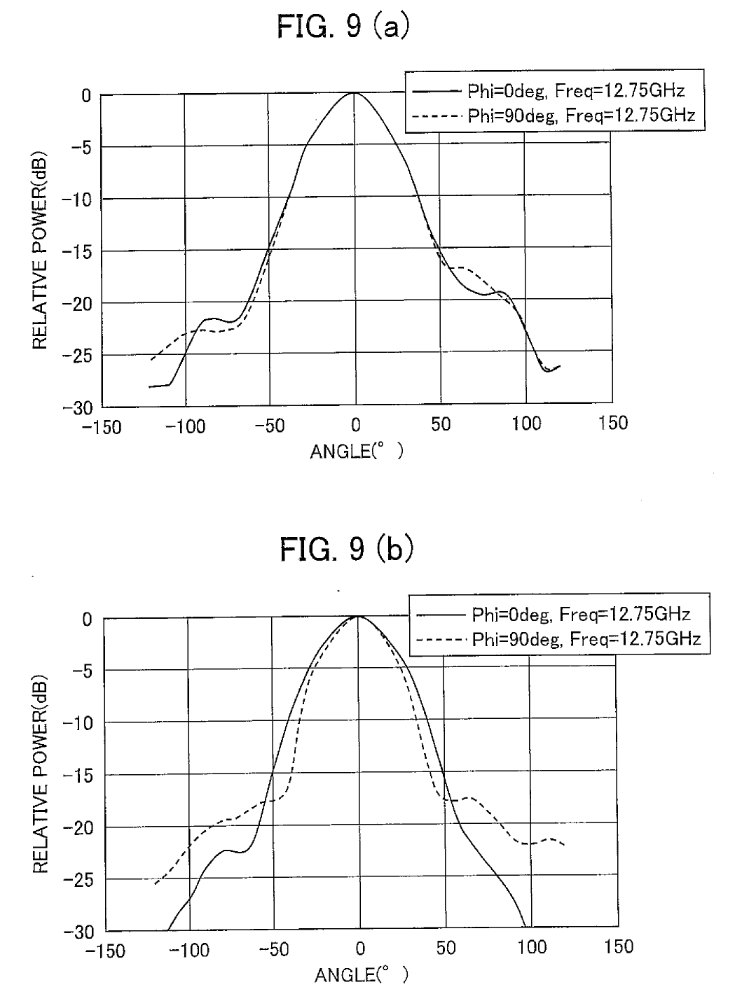

Moreover, the bending process improves the directivity of the primary radiator 8. To verify the directivity, a measurement was carried out at high bandwidth like 12.5 GHz which is currently used for the LNB. The results are shown in radiating pattern graphs of FIG. 9. FIG. 9(a) illustrates the result of the horn part with a bended flange end, and FIG. 9(b) illustrates the result of the horn part without a bended flange end. With a bended flange end, the directivities of Phi (φ) at 0 degree and 90 degrees were about equivalent to each other as illustrated in FIG. 9(a). Phi (φ) shows a directivity of the horn part. That is, a stable and good directivity was provided by the flange end 8c which was processed by bending.

[Supplementary Note]

The present invention is not limited to the description of the embodiments above, but may be altered by a skilled person within the scope of the claims. An embodiment based on a proper combination of technical means disclosed in different embodiments is encompassed in the technical scope of the present invention.

In a method of producing a primary radiator in accordance with embodiments of the present invention, a primary radiator is produced by deep-drawing one sheet metal to mold a waveguide and a horn part in one piece. So, the present invention is preferably applicable to production of a primary radiator, which requires a shorten process time and lower production cost.

### Summary of Embodiments

A primary radiator in accordance with an embodiment of the present invention includes a horn part and a waveguide which are molded in one piece by deep-drawing process.

A primary radiator is produced by deep-drawing a sheet metal to form a waveguide and a horn part in one piece so that a shorter process time and a lower production cost are attained.

Furthermore, in order to achieve the above object, a primary radiator in accordance with an embodiment of the present invention includes a horn part and a waveguide which are respectively formed by deep-drawing individual sheet metals, and are joined together in one piece.

In accordance with the above, the shapes of the horn part and the waveguide to be processed become simple so that deep-drawing process will be easier.

In addition to this embodiment, a primary radiator in accordance with an embodiment of the present invention includes the elliptical shaped cross section which is at right angle to the axis of the primary radiator.

Furthermore, a primary radiator in accordance with an embodiment of the present invention may include the rectangular shaped cross section which is at right angle to the axis of the primary radiator.

Moreover, a primary radiator in accordance with an embodiment of the present invention includes a flange of the horn part which is bended toward the waveguide. The bended flange is at a wide-open end of the horn part.

In accordance with this embodiment, the strength of the horn part is improved. The directivity of the primary radiator is also improved. Furthermore, this embodiment is more effective in reducing a noise than the conventional techniques in which a corrugated horn part is formed in a primary radiator.

A primary radiator in accordance with an embodiment of the present invention may include a horn part and a waveguide which are formed in one piece by deep-drawing process.

A primary radiator in accordance with an embodiment of the present invention may include a round shaped waveguide which is formed by deep-drawing a sheet metal.

A primary radiator in accordance with an embodiment of the present invention may include an elliptical shaped waveguide which is formed by deep-drawing a sheet metal.

A primary radiator in accordance with an embodiment of the present invention may include a rectangular shaped waveguide which is formed by deep-drawing a sheet metal.

A primary radiator in accordance with an embodiment of the present invention may include a horn part and a waveguide which are respectively formed by deep-drawing individual sheet metals, and joined together in one piece.

A primary radiator in accordance with an embodiment of the present invention may include an elliptical shaped waveguide, in which a horn part and a waveguide are respectively formed by deep-drawing individual sheet metals, and joined together in one piece.

A primary radiator in accordance with an embodiment of the present invention may include a rectangular shaped waveguide, in which a horn part and a waveguide are respectively formed by deep-drawing individual sheet metals, and joined together in one piece.

A primary radiator in accordance with an embodiment of the present invention may include a horn part and a waveguide which are combined and joined together in one piece.

A primary radiator in accordance with an embodiment of the present invention may include a horn part whose flange end is bended so that the strength is improved.

A primary radiator in accordance with an embodiment of the present invention may include a horn part whose flange end is bended so that the better directivity is provided.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A primary radiator comprising:
a horn part; and
a waveguide,
the horn part and the waveguide being molded in one piece by deep-drawing process.

2. The primary radiator in accordance with claim 1 having an elliptical shaped cross section at right angle to an axis thereof.

3. The primary radiator in accordance with claim 1 having a rectangular shaped cross section at right angle to an axis thereof.

4. A primary radiator comprising:
a horn part; and
a waveguide,
the horn part and the waveguide being respectively formed by deep-drawing process and joined in one piece.

5. The primary radiator in accordance with claim 4 having an elliptical shaped cross section at right angle to an axis thereof.

6. The primary radiator in accordance with claim 4 having a rectangular shaped cross section at right angle to an axis thereof.

7. The primary radiator in accordance with claim 1, wherein the horn part comprises a flange at a wide-open end, the flange having a portion bended toward the waveguide.

8. The primary radiator in accordance with claim 4, wherein the horn part comprises a flange at a wide-open end, the flange having a portion bended toward the waveguide.
